(19) United States
(12) Patent Application Publication
(10) Pub. No.: US 2022/0024641 A1
(43) Pub. Date: Jan. 27, 2022

(54) System and Method for Bag Closure Clip Production

(71) Applicant: Bedford Industries, Inc., Worthington, MN (US)

(72) Inventors: Mark Green, Sibley, IA (US); Trevor Wintz, Round Lake, MN (US); Isaac Christopher Steele, Worthington, MN (US)

(21) Appl. No.: 17/381,485

(22) Filed: Jul. 21, 2021

Related U.S. Application Data
(60) Provisional application No. 63/055,142, filed on Jul. 22, 2020.

(51) Int. Cl. B65D 33/16; B26F 1/14

(52) U.S. Cl. CPC B65D 33/1625; B26F 1/14

(57) ABSTRACT

A system is configured to produce a series of printed clips. The system includes a source of web material, a cutting station, a drive assembly and a printing station. The web material is configured to pass through the system in a machine direction. The cutting station is configured to cut a first portion of the web material into at least a first clip, index the first portion after cutting, and sequentially cut a second portion of the web material into at least a second clip. Cut portions of the web material exit the cutting station in a free loop. A drive assembly is configured to feed web material of the free loop through the printing station at a web speed. The printing station is configured to print indicia on a first surface of the cut portions of the web material.

### CROSS REFERENCE TO RELATED APPLICATIONS

This application claims the benefit of priority of U.S. Provisional Patent Application No. 63/055,142 filed on Jul. 22, 2020. This application is hereby incorporated by reference in its entirety.

### BACKGROUND

Plastic closure articles commonly known as “clip tags” are well known, as described in U.S. Pat. No. 4,026,413 to Britt and U.S. Pat. No. 4,911,293 to Holmes, for example. Such a clip tag is commonly used to close a flexible container such as a plastic bag. An open end of the bag is typically gathered and then inserted through a slit on the tag, so that the gathered bag is frictionally held in a hole of the tag.

Closure clips for bag closure applications are typically provided in a connected strip that is spooled for high volume and rapid dispensing. These clips are often used for closing plastic bags or net bags for produce or baked goods products. In order to provide information about the packaged product (in addition to performing its bag closure function), each such bag closure clip may have information printed thereon after clip production and immediately prior to or contemporaneous with being attached to a bag and separated from its strip. Alternatively, separate labels have been affixed to each clip while in strip from, such as by a suitable adhesive, in order to provide information on that label about the packaged product in a bag once the clip has been attached thereto.

### SUMMARY

In one aspect, a system is configured to produce a series of printed clips. The system includes a source of web material, a cutting station, a drive assembly and a printing station. The web material is configured to pass through the system in a machine direction. The cutting station is configured to cut a first portion of the web material into at least a first clip, index the first portion after cutting, and sequentially cut a second portion of the web material into at least a second clip. Cut portions of the web material exit the cutting station in a free loop. A drive assembly is configured to feed web material of the free loop through the printing station at a web speed. The printing station is configured to print indicia on a first surface of the cut portions of the web material.

In another aspect, a method is described for manufacturing a series of printed clips. The method includes conveying a web material through a system in a machine direction; cutting a first portion of the web material into at least a first clip; indexing the first portion after cutting the first portion; cutting a second portion of the web material into at least a second clip; paying out cut portions of the web material in a free loop; feeding web material of the free loop through a printing station at a web speed; and printing first indicia on a first surface of the cut portions of the web material.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. It is contemplated that all descriptions are applicable to like and analogous structures throughout the several embodiments.

FIG. 1 is a front view of a portion of a strip of bag closure clips with information printed thereon.

FIG. 2 is a front perspective view of an exemplary bag closure clip.

FIG. 3 is a front view of an exemplary bag closure clip.

FIG. 4A is a schematic diagram of an exemplary system for printing a strip of bag closure clips during strip formation.

FIG. 4B is a schematic diagram of a second exemplary system for printing a strip of bag closure clips during strip formation.

FIG. 5A is a more detailed schematic diagram of a portion of FIG. 4A designated “5” in a first exemplary system.

FIG. 5B is a more detailed schematic diagram of a portion of FIG. 4A designated “5” in a second exemplary system.

FIG. 5C is a more detailed schematic diagram of a portion of FIG. 4A designated “5” in a third exemplary system.

FIG. 6 is a perspective view of a spooled strip of pre-printed clips.

FIG. 7A is a schematic diagram illustrating a strip of clips having a right-hand clip orientation.

FIG. 7B is a schematic diagram illustrating a strip of clips having a left-hand clip orientation.

FIG. 8A is an elevation view of components of an exemplary print station.

FIG. 8B is a front right perspective view of the print station of FIG. 8A.

FIG. 8C is a rear perspective view of the print station of FIG. 8A.

FIG. 8D is a left front perspective view of the print station of FIG. 8A.

FIG. 9 is a perspective view of an exemplary track or support platen of the print station of FIG. 8A.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

### DETAILED DESCRIPTION

This disclosure relates to the production of bag closure clips in strip form (adapted to be wrapped into spools for later automatic and rapid dispensing of clips once produced), and specifically to the ability to print information on each bag closure clip during such production. This contrasts with conventional methods of printing information after production and at the point of use. The described systems and methods allow for high quality printing of clips including printing in multiple colors and on either side (front or back or both) of the clips, wherein the printed indicia are carefully registered to the cut clips so that each of the printed clips is identical in a production run. The printing may include multiple ink colors and/or compositions for a single clip. The described methods and systems provide for high quality printing at high speeds.

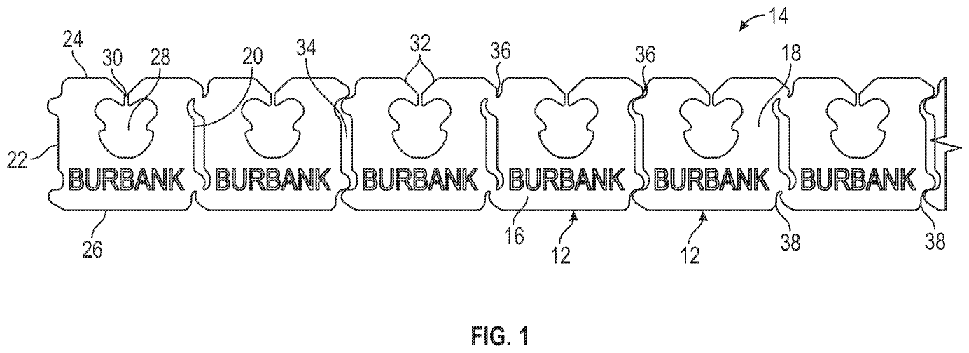

FIG. 1 is a front view of a portion of a strip 14 of bag closure clips with information printed on each clip during strip production. Each bag closure clip 12 in a strip 14 of such connected clips 12 bears printed indicia 16 thereon. In this example, the word “BURBANK” is identically printed on a portion of each clip 12, which will denote the variety of potato that will be in the package ultimately closed by one of these clips 12. Besides product varietal information, other packaged product information indicia may also be borne by the clip 12, including machine readable codes.

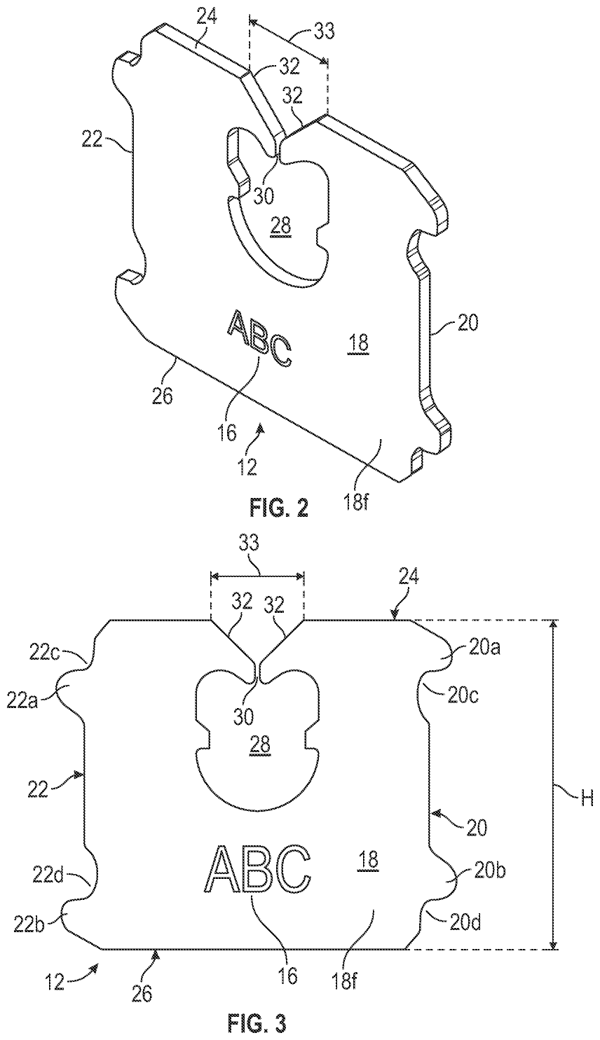

As ultimately formed for use in packaging (and as shown in FIGS. 2 and 3), each bag closure clip 12 has a clip body 18 that is generally rectangular, having side edges 20 and 22, a top bag receiving edge 24 and a bottom edge 26. A perimeter of the clip body 18 is defined by side edge 20, bottom edge 26, opposite side edge 22 and top bag receiving edge 24. In this disclosure, portions of the clip body 18 within the perimeter are considered to be “within” or “interior to” the clip body 18. Areas outside the perimeter are considered to be “outside” or “exterior to” the clip body 18. A hole 28 is formed within the clip body 18 for retention of a portion of a bag to which the clip 12 is attached. Hole 28 is in communication with an exterior of the clip body 18 via slit 30. Top edge 24 includes ramped portions 32 that aid in feeding that portion of the bag into hole 28 as the clip 12 is mounted onto the bag for closure thereof. In an exemplary embodiment, each of ramped portions 32 is inclined from the narrow slit 30 toward a wider opening 33 at top bag receiving edge 24.

The clips are formed by cutting a band 40 of clip web material. In one embodiment, band 40 is wider than a desired clip height H. In another embodiment, web band 40 has a width equal to a height H of a clip 12 between top bag receiving edge 24 and bottom edge 26. Cuts in the web are made to cut out the hole 28, slit 30 and ramped portions 32 in each clip 12, as well as to form that clip's sides 20 and 22. In a case in which band 40 is wider than clip height H, cuts are also made to form top bag receiving edge 24 and bottom edge 26—this results in exact reproducibility in the dimensions and indicia placement of each clip 12. Side 20 of each clip 12 includes clip strip connector nubs 20a and 20b, as well as clip strip connector recesses 20c and 20d. Likewise, side 22 of each clip includes clip strip connector nubs 22a and 22b, as well as clip strip connector recesses 22c and 22d. As a result of such cutting, strip 14 of connected clips 12 is formed, such as shown in FIG. 1. Adjacent clips 12 are attached to each other by two small uncut bridges of clip web material on their respective nubs 20a, 20b, 22a and 22b. These bridges are severed, for example, when an end clip 12 is detached from the strip 14, such as when that clip 12 is attached to a packaged product bag. The cutting of the web not only forms the hole 28, slit 30 and ramped portions 32, but also defines a cross-band slot 34 and cut corner gaps 36 (top) and 38 (bottom) between adjacent clips 12 (see FIG. 1).

In an exemplary embodiment, clip 12 is formed as a polymer sheet having a perimeter and includes a cut or slit 30 connecting the perimeter and hole or aperture 28. Many configurations of clip 12 and specifically of hole 28 can be used. In exemplary embodiments, clips 12 are formed of a stiffly resilient sheet plastic material that allows for deformation in use for ease of insertion of a portion of a bag into hole 28 and removal of the portion of the bag therefrom.

Rectangular style clips 12 are especially practical for economy purposes, but clips 12 may take different forms such as octagonal shapes, triangular shapes, rhomboidal shapes, circular shapes, oval shapes, and irregular shapes. The clip material should be flexible and pliable but is preferably not elastic, and is therefore dimensionally stable, for most applications. Such dimensional stability maintains the integrity of printed indicia 16, which is not distorted by stretching or other permanent deformation.

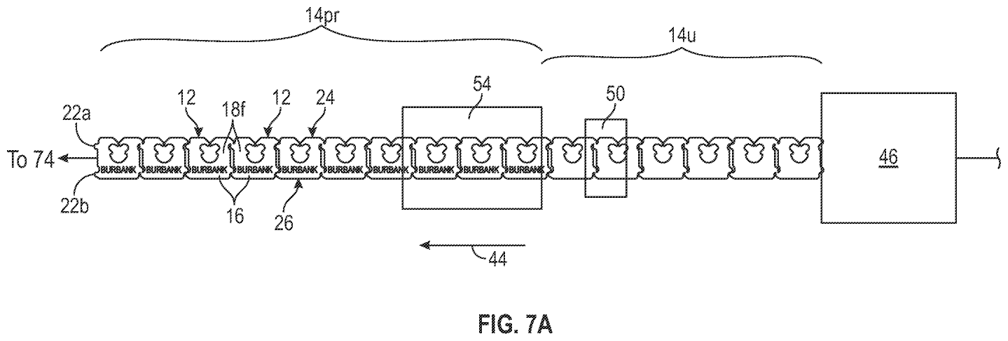

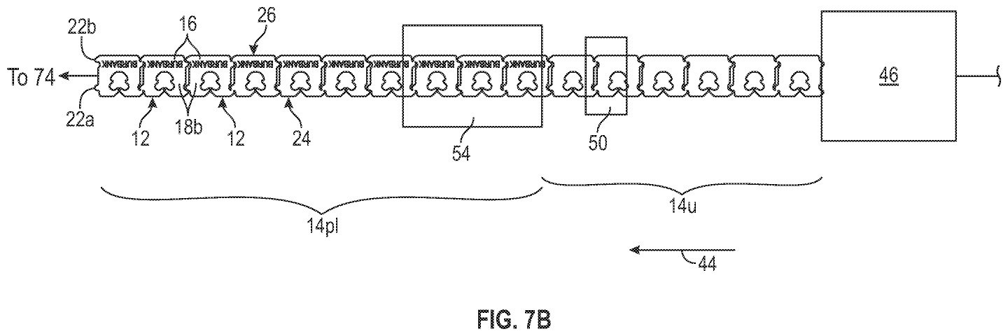

Indicia 16 are provided on a front surface 18f (as in FIGS. 1-3 and 7A) and/or opposite back surface 18b of clip 12 (as in FIG. 7B). Indicia may be printed, embossed, and/or otherwise provided. In exemplary embodiments, indicia 16 are sufficiently water resistant to avoid disintegration or destruction when repeatedly subjected to water and washing operations (as are common for produce displays in supermarkets). The sheet material for the clip 12 also should be somewhat tough in the sense of being sufficiently tear resistant to deter damage to it during storage, transport and display, or by staff or customer handling, even when damp or wet.

Especially suitable materials for forming the clip 12 include woven or non-woven fabrics, woven or non-woven films, paper, polymers, polystyrenic thermoplastics, polyolefinic thermoplastics, polyesters, and others that exhibit the properties discussed (which can vary depending on how the article is to be use). Suitable materials include thermoplastic materials and polymers of styrene, ethylene, propylene, as well as a variety of other monomers and mixtures of monomers (e.g., to make co-polymers and ter-polymers, etc.). Suitable materials also include PLA (poly lactic acid) resin materials. Any of a variety of commercially available inks compatible with, or accepted on, a web material strip and retained thereon, and in any desired color, may be used to print indicia 16 on clip 12. Moreover, if it should be desired to use water-soluble ink markings, a thin film of water-insoluble plastic may be applied over the ink to enhance water resistance.

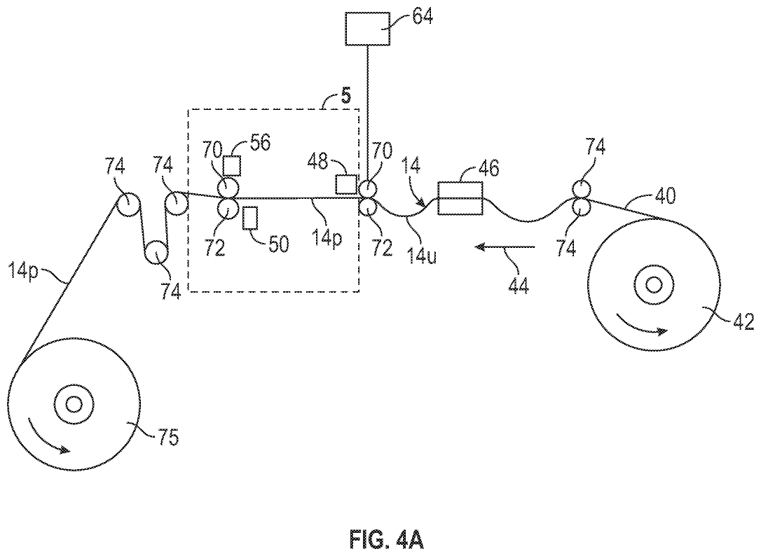

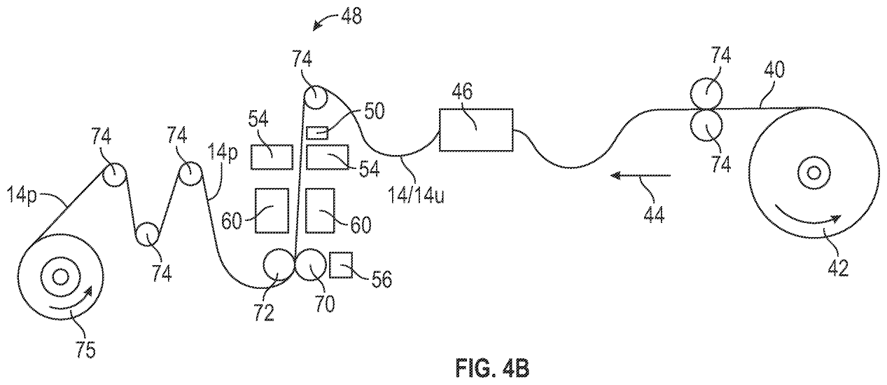

FIG. 4A schematically illustrates an exemplary web-based process for forming a strip 14 of clips 12 from a band 40 of clip web material that is provided in spooled form (band spool 42). The band 40 is advanced in a machine direction as depicted by arrow 44 through a cutting station 46. At cutting station 46, a portion of band 40 is cut (such as by punch die cutting) to define the shape of each clip 12 and thereby, the strip 14 of connected clips 12. In an exemplary embodiment, a portion of the band having a length corresponding to several clips 12 is cut simultaneously. Then the band is indexed to allow for cutting of the next portion to form another several clips 12 simultaneously. In another embodiment, cutting station 46 may cut and index only a single clip 12 at a time. As process operations go, this cutting action is violent, chopping portions of the band 40 away therefrom to form clips 12, removing clip web material from the band to define the holes 28, slits 30, ramped portions 32, slots 34 and top and bottom corner gaps 36 and 38 (and also the top edge 24 and/or bottom edge 26 if the band 40 is wider than a desired clip height H). The band 40 is subject to abrupt jerking motions as the cutting head of cutting station 46 engages and disengages the band 40, and as the band 40 is indexed in machine direction 44 for each subsequent cutting operation (i.e., to form each portion consisting of several clips 12). The removed portions of the band are collected at the cutting station 46 for recycling and reuse. In one exemplary embodiment, the cutting station 46 includes a punch press and a servo indexer for intermittent advancement of the band 40 into the punch press.

Upon exiting the cutting station 46, the now formed strip 14 of clips 12 is advanced through a printing station 48. At the printing station 48, indicia 16 are printed or otherwise imparted on each clip as desired to provide information about the product packaged in the bag to which that clip 12 is later attached. It is important that the printed indicia disposed on each clip 12 in the strip 14 (such as indicia 16 shown in FIG. 1) be in the same location on each clip 12, from clip to clip along the strip 14, so that the final clips attached to packaged product bags look uniform from bag to bag.

This alignment objective is achieved by precise print alignment with the shape of the clip onto which the print indicia are being applied. As opposed to the violent cutting process accomplished at the cutting station 46, the print process performed at the printing station 48 in an exemplary embodiment is performed on a strip 14 that moves stably and uniformly along machine direction 44 as printing ink is applied thereto. As band 40 exits cutting station 46 as a cut strip 14 of clips 12, the strip is unprinted prior to entering printing station 48; the unprinted portion is designated 14u. The unprinted strip 14u is allowed to sag between cutting station 46 and printing station 48 in a “free loop” by controlled nip roll 70 and drive roll 72. While two sets of rolls 70, 72 are illustrated in FIG. 4A, in another case, a single set of rolls 70, 72 is sufficient. Any number of roller sets can be used to provide the desired amount of control of a web speed for printing onto unprinted strip 14u.

Portions of band 40 exiting the cutting station 46 hang in the free loop, being introduced thereto in indexed increments from the cutting station 46. Although the band 40 is introduced into the free loop in abrupt segments, it is smoothly paid to the printing station 48 at a controlled rate that can be influenced by a length of the free loop (which can be determined by sensors not shown and sensor signals fed to process controller 64).

The described system controls when to start (and stop) printing for each clip 12 and the rate of advance of that clip 12 through the printing station 48; such control ensures the exact placement of printed indicia 16 on each clip 12. In addition, precise registration of the applied printed indicia with the shape of the clip 12 results in each clip 12 of the strip 14 being identical in appearance. These goals are achieved by the use of one or more sensors that detect the position of the strip 14 relative to the printing station 48 (and more specifically to an ink dispensing printer disposed in the printing station 48), and by detecting the rate of advance of the strip 14 in the machine direction 44 relative to the printing station 48. Additional sensors and encoders can be positioned upstream or downstream of their illustrated positions in other specific applications that are not illustrated.

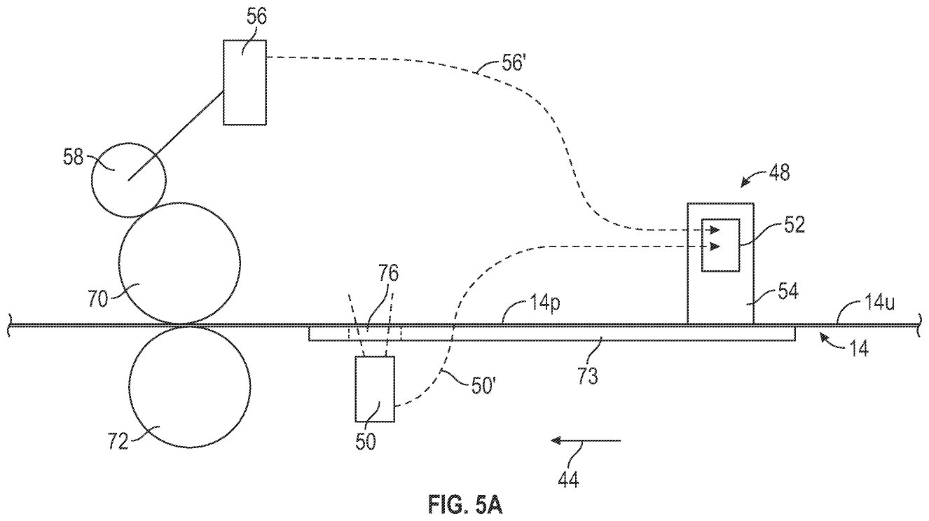

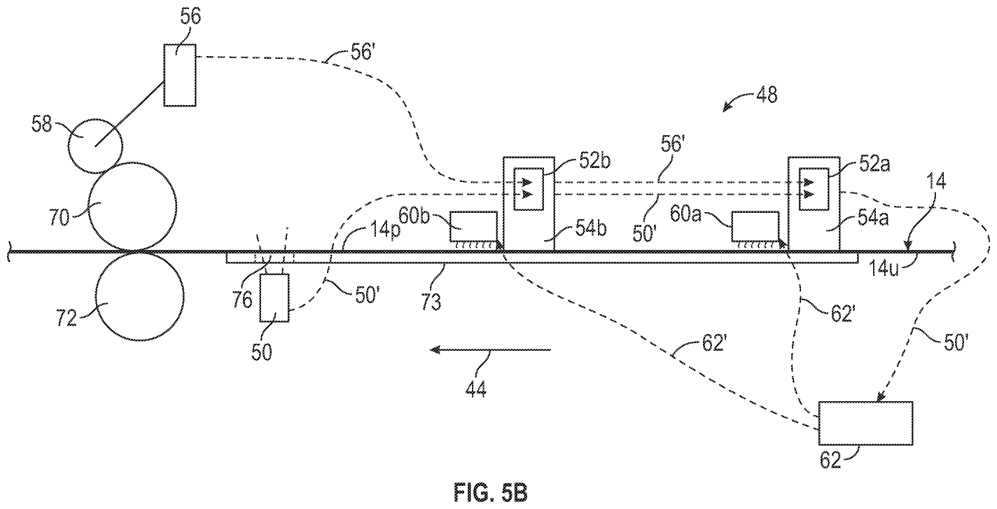

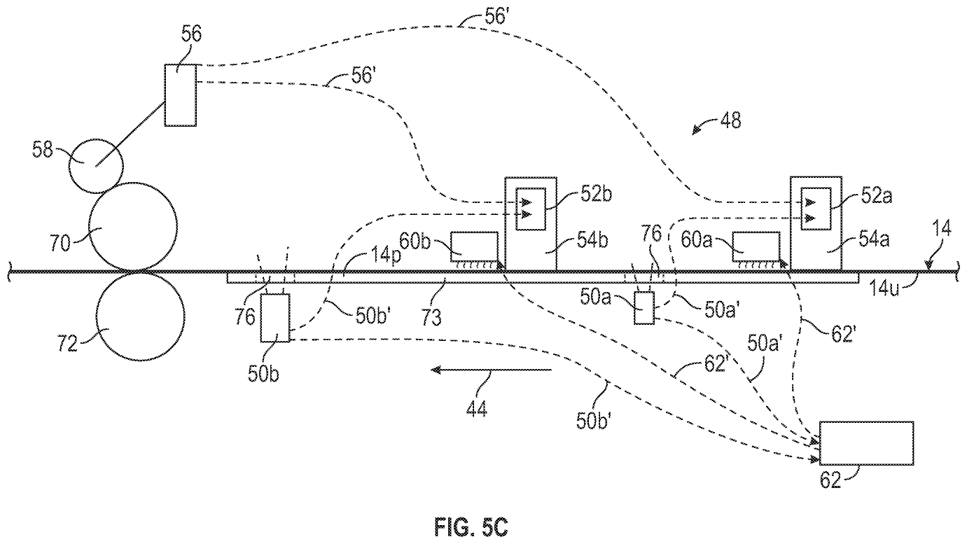

Such sensors may be placed downstream and/or upstream from the printing station 48 (along the machine direction 44) but preferably in proximity to the printing station 48. In an exemplary embodiment as shown in FIG. 5A, a clip edge sensor 50 is provided downstream from the printing station 48 to detect a specific edge of each clip 12 in the strip 14 as it traverses sensor 50 (such as detection of an edge of hole 28 on that clip 12, or a side 20 or 22 of that clip along one of its associated slots 34). As noted in FIG. 5A, sensor 50 sends a signal 50′ to a print controller 52 that is used to activate an ink dispensing printer 54 at printing station 48 to print indicia 16 on the clip 12 at the printing station 48 (not usually the same clip 12 in the strip 14 that is being detected by sensor 50). Using a known distance between the sensor 50 and the printer 48, and known geometry of the clips 12 of strip 14, such as a width of each clip 12, and a sensed rate of web motion in direction 44, the print controller 52 calculates the position of the clip 12 on which it is printing based on information of sensor 50 relative to a clip that is close to but not at the clip undergoing printing. Signal 50′ is employed to initiate printing at printing station 48. In some drawing figures, the strip 14 of connected clips 12 upstream from the printing station 48 is denoted as strip 14u (unprinted) and the strip of connected clips 12 downstream from the printing station 48 (and thus each bearing printed indicia 16) is denoted as strip 14p (printed).

In an exemplary embodiment, sensor 50 is an optical sensor that is tuned to detect an edge of the hole 28 in each clip 12 passing thereby. Signal 50′ is transmitted to print controller 52 upon each such detection for the purpose of triggering the print function. One type of optical sensor suitable for this task is a photoelectric sensor available as model D-79183 from SICK AG, Germany. Sensors not illustrated may be used to determine a size or length of the free loop designated as 14u. Moreover, in an exemplary embodiment, signals from those sensors are transmitted to process controller 64 for the purpose of determining a rate of motion imparted to the cut web strip 14 at rolls 70, 72 to feed the band smoothly to print station 48. If the free loop is longer than desired, a speed of rolls 70, 72 may be increased to take up the excess length. On the other hand, if the free loop is shorter than desired, rolls 70, 72 may be slowed down to allow more length of strip 14u to sag.

In an exemplary embodiment, the achievement of properly aligned indicia 16 on each clip 12 factors in the rate of movement of the strip 14 through the printing station 48. Encoder sensor 56 can be arranged to track the speed of strip 14 directly, or may do so indirectly as illustrated, for example, in FIG. 5A. Encoder sensor 56 includes an encoder wheel 58 that engages nip roll 70. Strip 14 is driven past and under nip roll 70 by opposed drive roll 72, which also establishes the rate of advance of the strip 14 past the printing station 48. Encoder sensor 56 sends a signal 56′ to print controller 52 that is used to control the rate of ink deposition by dispensing printer 54 at printing station 48 to print indicia on the clip 12 at the printing station 48.

In an exemplary embodiment, encoder sensor 56 is an electromechanical feedback device that provides information about the speed of the strip 14p as it passes the sensor 56. Signal 56′ is transmitted to print controller 52 for the purpose of controlling the rate of operation of the print function at printing station 48. One type of encoder sensor suitable for this task is the ACCU-CODER™ model from Encoder Products Company of Sandpoint, Id.

In an exemplary embodiment, one suitable printer 54 is a Markem-Imaje cartridge-type solvent thermal industrial Inkjet Model 1050, available from Markem-Imaje, of Keene, N.H. a wholly owned subsidiary of Dover Corporation, Downers Grove, Ill. In this instance, since the ink is solvent-based, it requires some processing time to dry before engaging another surface such as nip roll 70, to avoid ink smearing. Other suitable equipment for printer 54 is a piezoelectric impulse printer that uses an ultraviolet light emitting diode (LED) ink curing system, as model 905 Series for Kwik Lok, available from Squid Ink Manufacturing of Brooklyn Park, Minn. Another suitable printer 54 is commercially available from Squid Ink Manufacturing as model CoPilot Max industrial inkjet printing system.

As seen in FIG. 5A, in an exemplary embodiment, the processing path for strip 14 includes (at least at and proximate the printing station 48) a planar track or support platen 73. The platen 73 provides a stable surface for the strip 14 to traverse during the precise registration and printing process used to repeatedly align the printed indicia 16 on each clip 12 of the strip 14. The platen 73 is disposed under the strip 14 at the printer 54 and has suitable edges or channels to support and align the strip 14 as printing ink is applied thereto.

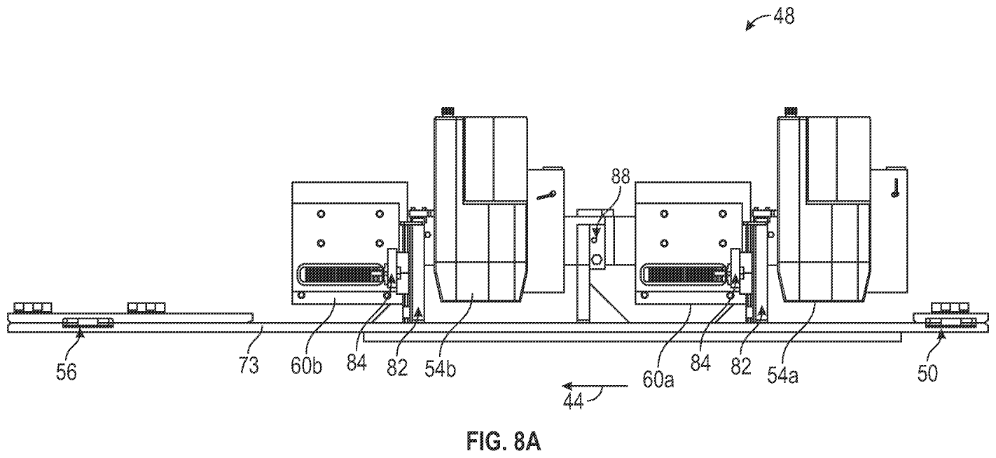

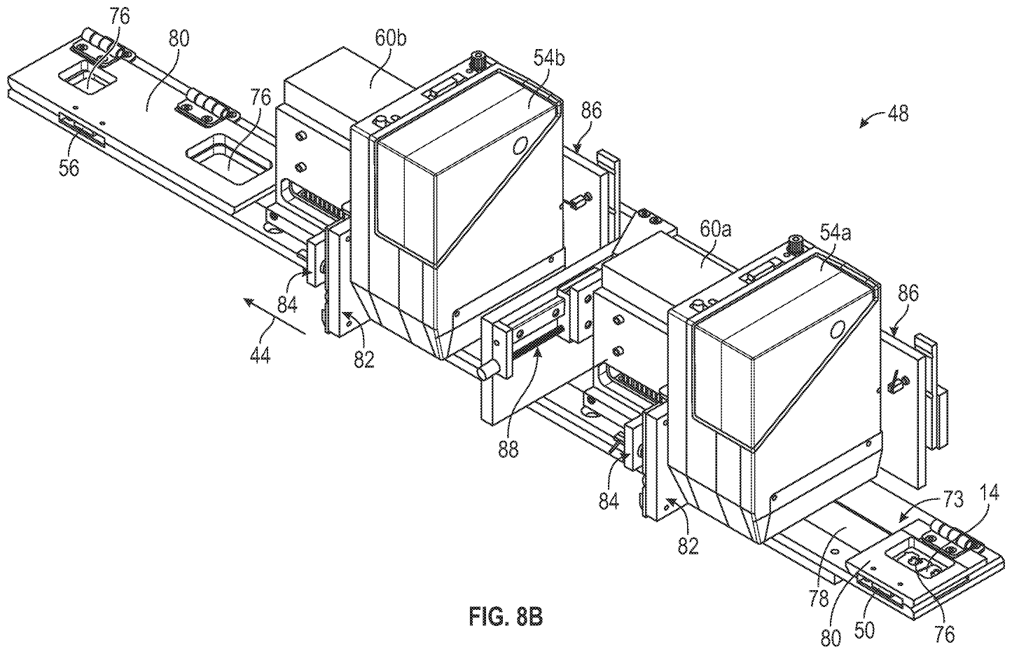

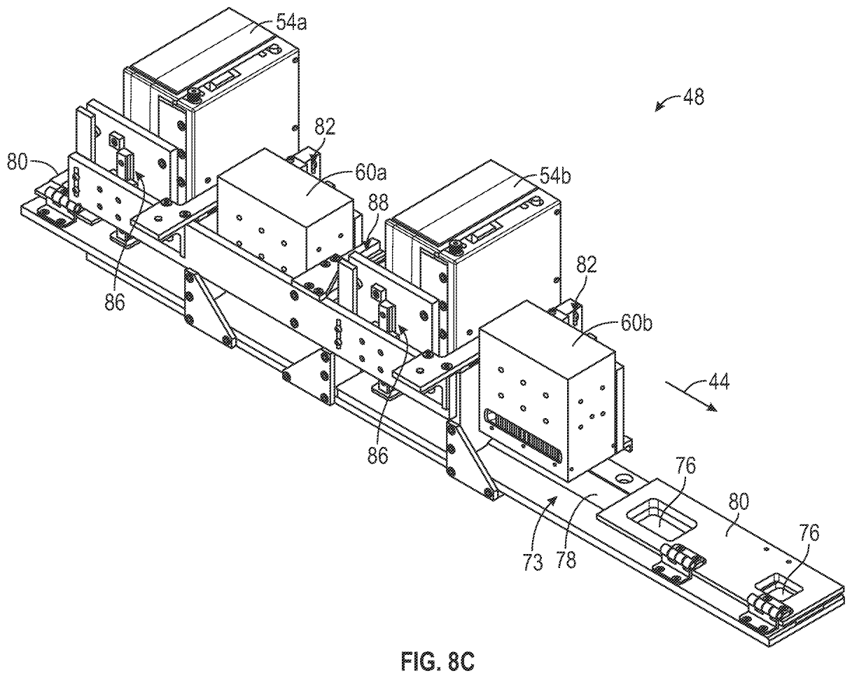

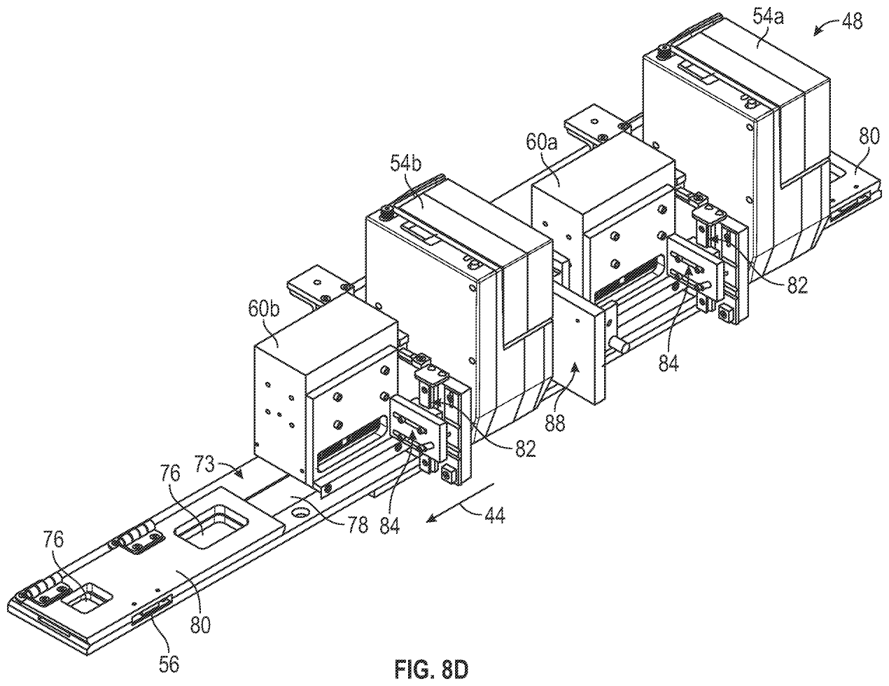

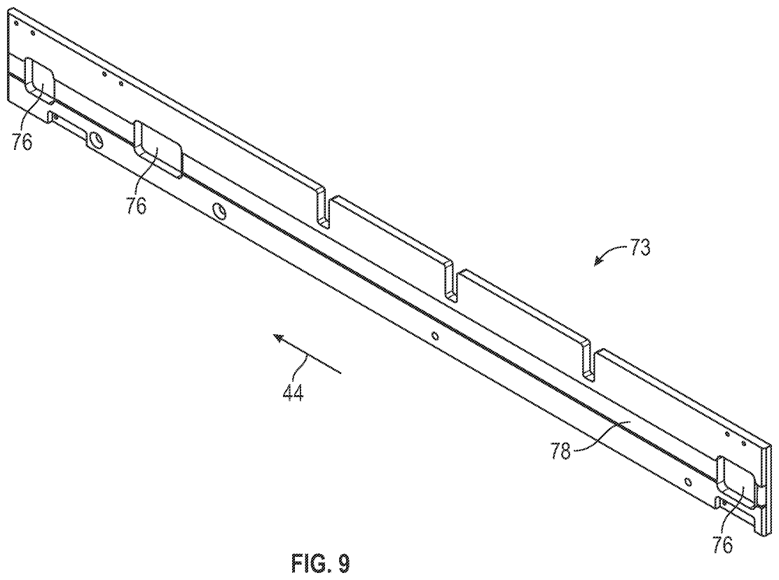

For example, as shown in FIGS. 8B-9, in an exemplary embodiment platen 73 includes channel 78 having a width just slightly greater than a height H of the strip 14 of clips 12. The width of channel 78 is measured perpendicular to the longitudinal machine direction 44. Different support platens 73 can be interchangeably mounted in the production system, depending on a dimension of a desired produced clip 12. For example, a clip 12 that has a height H of 0.844 inch (21.44 mm) can be used with a support platen 73 that has a channel 78 with a width that is about 0.100 inch (2.54 mm) greater than H. In an exemplary embodiment, although visually imperceptible in the drawings, the width of channel 78 necks down to being only about 0.020 inch (0.51 mm) wider than H in the vicinity of printer 54. This narrowed width of the channel 78 at the printer gives greater accuracy in the location of the printed indicia 16 in the transverse direction that is perpendicular to the machine direction 44. At the same time, the slightly wider channel dimension away from the printer 54 reduces drag and prevents the web band 40 from getting caught and breaking in the channel 78.

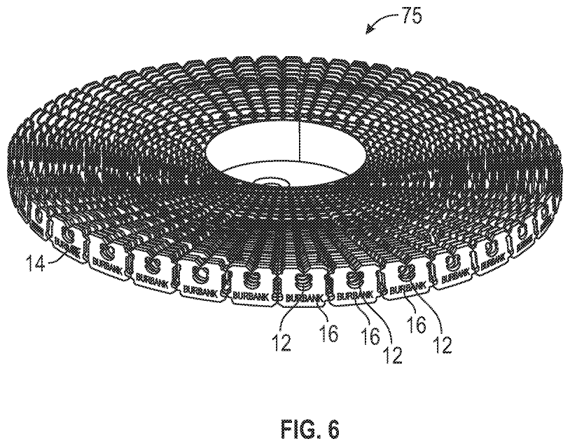

In the illustrated embodiment, the sensor 50 is mounted under an opening 76 in the platen 73 that permits the sensor 50 to detect the necessary characteristic (gap or edge) of the clip 12 passing over that opening 76, for production of a signal 50′ for each clip so detected. After the strip 14p has traversed the nip and drive rolls 70 and 72, it passes through staging and idler rollers 74 and then is wound about a driven hub into a pre-printed clip spool 75. Each clip 12 on spool 75 has the same shape and bears the same indicia printed thereon. Such a spool 75, as illustrated in FIG. 6, is then provided to a product packaging facility for use in tagging and closing product packaging bags by sequential removal and attachment of the clips 12 thereon onto bags of packaged product.

FIG. 5B is similar to FIG. 5A but shows an embodiment of a clip production system in which the printing station 48 includes two printers 54a, 54b, each having an ink curing unit 60a, 60b, such as an ultraviolet (UV) lamp or ink jet curing unit. While two printers 54a, 54b, are illustrated, it is to be understood that more printers can be used in a production line, as desired. For example, each printer 54 may be configured to print a different color of ink. In an exemplary embodiment, the printer 54a prints on the unprinted strip 14u first, for example imparting indicia 16 having a relatively light color on clip body 18. This light color print is completely cured onto the clip 12 by curing unit 60a, before the second printer 54b prints onto the now printed clip 12 with a second ink deposition, such as that of a darker ink color. The doubly printed clip 12 is then passed under the second curing unit 60b so that the second ink deposition is fully cured. Because each of the ink depositions is individually cured, overlapping areas of ink deposition between the multiple printers will not degrade print quality, as each print is cured before additional ink is deposited. In an exemplary embodiment, each of the printers of the production line is a similar type of printer and deposits a similar type of ink, curable by similar curing units. However, it is contemplated that in a production line, a user may wish to use printers of different types, depositing different ink formulations, and using different curing methods. In an exemplary embodiment, each of the printers 54 deposits a single color of ink. However, in other cases, a printer may be supplied with inks of a multitude of colors, which can be deposited in mixtures to provide a nearly infinite selection of finished colors. In an exemplary embodiment, at least signal 50′ indicating a position of a clip is sent to curing unit controller 62, which sends control signals 62′ to the curing units 60a and 60b for turning on and off a UV lamp as a clip with freshly deposited ink is passed thereunder.

FIG. 5C is similar to FIG. 5B but shows an embodiment of a clip production system printing station 48 wherein each of the printers 54a, 54b has a respective clip edge sensor 50a, 50b. For example, FIG. 5C shows that clip edge sensor 50a is in signal communication with printer 54a, and that second clip edge sensor 50b is in signal communication with second printer 54b. The drawings are not drawn to scale. In an exemplary embodiment, each of the position sensors 50a, 50b is placed quite close to the print head of a respective printer 54a, 54b, such as within about two clips 12, traveling through the system in direction 44. FIG. 5C shows a system in which each of the clip edge sensors 50a, 50b sends its respective signal 50a′, 50b′ to curing unit controller 62. The curing unit controller 62 sends signals 62′ to the two curing units 60a, 60b to turn their respective lamps on and off at appropriate times to cure the newly deposited ink on a clip passing thereby. In another case, it is sufficient for a single signal 50a′ or 50b′ from either of the sensors 50a, 50b to be passed to curing unit controller 62, which then controls the on and off operation of the curing units 60a, 60b simultaneously. While some embodiments show a clip position sensor 50 downstream of a printer to which it sends a position signal, FIGS. 4B and 8A-8D show embodiments of a production system printer station in which sensor 50 is located upstream of the printer(s) 54 to which it sends a position signal. In other cases, multiple sensors 50 can be placed both upstream and downstream of corresponding printers. Moreover, the sensors 50 associated with each of the printers 54 can be located at different distances with respect to their respective printers.

FIG. 4B is a schematic diagram illustrating components of a clip production system in which both sides of the clip body, such as the front and back body surfaces 18f, 18b of the clip 12 can be printed simultaneously. In contrast to the systems illustrated in FIGS. 4-5C, in which the printer is configured to direct ink downward with the assistance of gravity, in FIG. 4B, the printers 54 are configured to deposit ink onto vertically disposed front and back surfaces of clips traveling along strip 14. Other features of the system have been described above.

FIG. 7A is a top, front view of clips printed on a strip in what is referred to as a right-hand orientation, with printing on the front surfaces 18f of the clip bodies, as shown in FIGS. 1-3. With such a right-hand orientation, strip connector nubs 22a and 22b are located on a leading edge of clip 12 traveling in machine direction 44. A printed portion of the strip 14 printed in such a right-hand orientation is designated 14pr.

FIG. 7B is a top, rear view of clips printed on a strip in what is referred to as a left-hand orientation, with printing on the back surfaces 18b of the clip bodies (opposite of the front major surfaces as shown in FIGS. 1-3). A printed portion of the strip 14 printed in such a left-hand orientation is designated 14pl. While using the production line embodiments of FIGS. 4-5C, a back surface 18b of the clip bodies 18 can be printed by flipping the orientation of the strip configuration being cut at cutting station 46. As shown in FIG. 7B, the strips connector nubs 22a, 22b remain on the leading edge of a strip 14 traveling in the machine direction 44. However, the strip is flipped upside down compared to the configuration of FIG. 7A, so that the back face of the clip body 18b faces upward to accept ink from printer 54. The clips that are printed during production on back of the clip body 18b can then be spooled and provided to a bagging facility. At the bagging facility, conventional printing equipment can be used to specifically print information on the unprinted front of the clip body 18b. For example, the back of the clip body 18b may include durable information such as a producer name and logo, while the front of the clip body 18f may bear more targeted information such as a packaging date or lot number.

Thus, in the clip production systems of the current description, either or both clip body sides 18f, 18b of clips 12 may be printed in a highly accurate, fast and quality-controlled clip production process. Based on known geometry and distances between the printers 54 and the clip edge sensor 50, as well as line speed information from encoder sensor 56, the system, through process controller 64 and printer controllers 52, is able to trigger all printers 54 for carefully registered deposition of indicia 16 on traveling clips 12 on strip 14, so that each of the many plurality of clips of the printed strip 14p, 14pr, 14pl bears indicia 16 in an identical location on each clip body 18f, 18b.

FIGS. 8A-8D show elevation, front right perspective, rear, and front left perspective views, respectively, of an exemplary printing station 48 for use in the described system. As shown in FIG. 8B, strip 14 travels through the printing station 48 in machine direction 44 within track 78 of platen 73. In an exemplary embodiment, at least in the vicinity of clip edge sensor 50 and encoder sensor 56, a hinged plate 80 is provided over the platen 73 to ensure that strip 14 lays flat in the channel 78 as its position and speed are sensed by sensors 50, 56.

In an exemplary embodiment, alignment devices are provided for each of the printers 54 and curing units 60 to precisely position these components with respect to a strip 14 travelling in channel 78. In this embodiment, the curing unit 60 is provided as an ultraviolet lamp and therefore will sometimes be referred to as a lamp. However, it is to be understood that alignment devices can also be provided for other types of curing units. The alignment devices in an exemplary embodiment include vertical lamp sliders 82, horizontal lamp adjusters 84, vertical printer sliders 86, and horizontal printer adjuster 88.

As shown in FIGS. 8B and 8C, both printers 54a, 54b are attached by brackets to a single horizontal printer adjuster 88 to move the printers 54a, 54b in unison forward and backward (perpendicular to machine direction 44) to align the print heads with a desired print location on a strip traveling in channel 78. The common adjustment of a horizontal position of both printers 54a, 54b in tandem helps to ensure identical placement of printed indicia 16 on the produced clips 12. In an exemplary embodiment, vertical printer sliders 86 are provided individually for each of the printers 54a, 54b. As shown in FIG. 8D, in an exemplary embodiment, each of the lamps 60a, 60b is provided with its own vertical lamp slider 82 and horizontal lamp adjuster 84.

An exemplary horizontal printer adjuster 88 is a commercially available high-load positioning slide for a fine transverse adjustment, as part 9222T11 from McMaster-Carr of Chicago, Ill. For each of vertical lamp sliders 82, horizontal lamp sliders 84 and vertical printer slider 86, a combination of carriage and rail elements for linear adjustments are available from McMaster-Carr. For example, a high-cycle low-profile ball bearing carriage is available under part number 7917N11. A suitable guide rail for a high-cycle low-profile ball bearing carriage is available under part number 7917N29.

Non-limiting examples of systems and methods are described herein. In an exemplary embodiment, a system is configured to produce a series 14p of printed clips, the system including a source 42 of web material 40, a cutting station 46, a drive assembly 70, 72 and a printing station 48. The web material 40 is configured to pass through the system in a machine direction 44. The cutting station 46 configured to cut a first portion of the web material 40 into at least a first clip 12. In an embodiment, the cutting station is configured to cut the first portion of the web material 40 into a first plurality of clips 12. The cutting station 46 is configured to index the first portion after cutting to sequentially cut a second portion of the web material 40 into at least a second clip 12. In an embodiment, the cutting station is configured to cut the second portion of the web material into a second plurality of clips 12. Cut portions of the web material 40 exit the cutting station in a free loop 14u. The drive assembly 70, 72 is configured to feed web material 40 of the free loop 14u through a printing station 48 at a web speed. The printing station 48 is configured to print indicia 16 on a first surface 18f, 18b of the cut portions of the web material.

In an exemplary embodiment, the printing station 48 includes a clip sensor 50 spaced from a printer 54, wherein the clip sensor 50 is configured to send a clip location signal 50′ to the printer 54. In an exemplary embodiment, the clip sensor 50 is disposed upstream of the printer 54 with respect to the machine direction 44. In another exemplary embodiment, the clip sensor 50 is disposed downstream of the printer 54 with respect to the machine direction 44.

In an exemplary embodiment, a platen 73 is configured to support the web material 14u as the web material is fed through the printing station 48, wherein the clip sensor 50 is located below the platen 73 and is configured to sense the clip location through an aperture 76 in the platen 73. In an exemplary embodiment, a platen 73 is configured to support the web material 14u in a channel 78 as the web material is fed past a printer 54 of the printing station 48; the channel 78 has a first width in a vicinity of the printer 54 and a second width remote from the printer 54, the second width being greater than the first width.

In an exemplary embodiment, an encoder sensor 56 is configured to detect the web speed. In an exemplary embodiment, a controller 64 is configured to change operation of the drive assembly 70/72 to thereby change the web speed. In an exemplary embodiment, a curing unit 60 is configured to cure the printed indicia 16 on the first surface 18f, 18b of the cut portions of the web material.

In an exemplary embodiment, the printing station 48 includes a first printer 54a configured to place a first ink deposition on the first surface 18f, 18b and a second printer 54b configured to place a second ink deposition on the first surface 18f, 18b. In an exemplary embodiment, the printing station 48 includes a first curing unit 60a configured to cure the first ink deposition and a second curing unit 60b configured to cure the second ink deposition. In an exemplary embodiment, at least one of the first and second curing units 60a, 60b includes a vertical position slider 82. In an exemplary embodiment, at least one of the first and second curing units 60a, 60b includes a horizontal position adjuster 84.

In an exemplary embodiment, the printing station 48 includes a horizontal printer adjuster 88 configured to change a horizontal position of both the first printer 54a and the second printer 54b in tandem. In an exemplary embodiment, the printing station 48 includes a vertical printer slider 86 configured to change a vertical position of at least one of the first and second printers.

In an exemplary embodiment as shown in FIG. 4B, the printing station 48 includes a first printer 54 configured to place a first ink deposition on the first surface 18f (or 18b) and a second printer 54 configured to place a second ink deposition on a second surface 18b (or 180 that is opposite the first surface 18f (or 18b). In an exemplary embodiment, the printing station 48 includes a first curing unit 60 configured to cure the first ink deposition and a second curing unit 60 configured to cure the second ink deposition. In an exemplary embodiment, placing the first ink deposition on the first surface is contemporaneous with placing the second ink deposition on the second surface.

In an exemplary embodiment, a method for manufacturing a series of printed clips 14p includes conveying a web material 40 through a system in a machine direction 44; cutting a first portion of the web material into at least a first clip 12; indexing the first portion after cutting the first portion; cutting a second portion of the web material into at least a second clip 12; paying out cut portions of the web material in a free loop 14u; feeding web material of the free loop 14u through a printing station 48 at a web speed; and printing first indicia 16 on a first surface 18f (or 18b in a second case) of the cut portions of the web material. In an exemplary embodiment, the method includes printing second indicia 16 on a second surface 18b (or 18f in the second case), opposite the first surface 18f (or 18b in the second case), of the cut portions of the web material. In an exemplary embodiment, printing the first indicia on the first surface and printing the second indicia on the second surface occur in tandem.

In an exemplary embodiment, the method includes adjusting a horizontal position of a printer 54 relative to a platen 73 that is configured to support the cut portions of the web material. In an exemplary embodiment, the method includes adjusting a horizontal position of multiple printers 54 in tandem relative to a platen 73 that is configured to support the cut portions of the web material. In an exemplary embodiment, the method includes adjusting a vertical position of a printer 54 relative to a platen 73 that is configured to support the cut portions of the web material. In an exemplary embodiment, the method includes adjusting a horizontal position of a curing unit 60 relative to a platen 73 that is configured to support the cut portions of the web material. In an exemplary embodiment, the method includes adjusting a vertical position of a curing unit 60 relative to a platen 73 that is configured to support the cut portions of the web material. In an exemplary embodiment, the method includes removing a first platen 73 and replacing it with a second platen 73, wherein each of the first and second platens includes a channel configured to support the cut portions of the web material, and wherein the channel of the first platen has a different dimension than a channel of the second platen.

In an exemplary embodiment, the method includes monitoring a length of a free loop 14u and adjusting a speed of a drive assembly 70, 72 based on the length of the free loop, to thereby change the web speed.

Although the subject of this disclosure has been described with reference to several embodiments, workers skilled in the art will recognize that changes may be made in form and detail without departing from the scope of the disclosure. In addition, any feature disclosed with respect to one embodiment may be incorporated in another embodiment, and vice-versa. All references mentioned in this disclosure are hereby incorporated by reference.

1. A system configured to produce a series of printed clips, the system including:
a source of web material, wherein the web material is configured to pass through the system in a machine direction;
a cutting station configured to cut a first portion of the web material into at least a first clip, the cutting station configured to index the first portion after cutting to sequentially cut a second portion of the web material into at least a second clip, wherein cut portions of the web material exit the cutting station in a free loop;
a drive assembly configured to feed web material of the free loop through a printing station at a web speed; and
the printing station configured to print indicia on a first surface of the cut portions of the web material.

2. The system of claim 1 wherein the printing station includes a clip sensor spaced from a printer, wherein the clip sensor is configured to send a clip location signal to the printer.

3. The system of claim 2 wherein the clip sensor is disposed upstream of the printer with respect to the machine direction.

4. The system of claim 2 wherein the clip sensor is disposed downstream of the printer with respect to the machine direction.

5. The system of claim 2 comprising a platen configured to support the web material as the web material is fed through the printing station, wherein the clip sensor is located below the platen and is configured to sense the clip location through an aperture in the platen.

6. The system of claim 1 including an encoder sensor configured to detect the web speed.

7. The system of claim 1 including a controller configured to change operation of the drive assembly to thereby change the web speed.

8. The system of claim 1 including a platen configured to support the web material in a channel as the web material is fed past a printer of the printing station, wherein the channel has:
a first width in a vicinity of the printer; and
a second width remote from the printer, the second width being greater than the first width.

9. The system of claim 1 including a curing unit configured to cure the printed indicia on the first surface of the cut portions of the web material.

10. The system of claim 1 wherein the printing station includes:
a first printer configured to place a first ink deposition on the first surface; and
a second printer configured to place a second ink deposition on the first surface.

11. The system of claim 10 wherein the printing station includes:
a first curing unit configured to cure the first ink deposition; and
a second curing unit configured to cure the second ink deposition.

12. The system of claim 11 wherein at least one of the first and second curing units includes a vertical position slider.

13. The system of claim 11 wherein at least one of the first and second curing units includes a horizontal position adjuster.

14. The system of claim 10 wherein the printing station includes a horizontal printer adjuster configured to change a horizontal position of both the first printer and the second printer in tandem.

15. The system of claim 10 wherein the printing station includes a vertical printer slider configured to change a vertical position of at least one of the first and second printers.

16. The system of claim 1 wherein the printing station includes:
a first printer configured to place a first ink deposition on the first surface; and
a second printer configured to place a second ink deposition on a second surface that is opposite the first surface.

17. The system of claim 16 wherein the printing station includes:
a first curing unit configured to cure the first ink deposition; and
a second curing unit configured to cure the second ink deposition.

18. The system of claim 16 wherein placing the first ink deposition on the first surface is contemporaneous with placing the second ink deposition on the second surface.

19. A method for manufacturing a series of printed clips, the method including:
conveying a web material through a system in a machine direction;
cutting a first portion of the web material into at least a first clip;
indexing the first portion after cutting the first portion;
cutting a second portion of the web material into at least a second clip;
paying out cut portions of the web material in a free loop;
feeding web material of the free loop through a printing station at a web speed; and
printing first indicia on a first surface of the cut portions of the web material.

20. The method of claim 19 including printing second indicia on a second surface, opposite the first surface, of the cut portions of the web material.
